(19) United States
(12) Patent Application Publication
(10) Pub. No.: US 2007/0218394 A1
(43) Pub. Date: Sep. 20, 2007

(54) Carrier, image formation method and image forming apparatus

(76) Inventors: Takeo Mizobe, Osaka-shi (JP); Norio Kubo, Osaka-shi (JP)

Correspondence Address: CLARK & BRODY, 1090 VERMONT AVENUE, NW, SUITE 250, WASHINGTON, DC, 20005, US

(21) Appl. No.: 11/723,046

(22) Filed: Mar. 16, 2007

(30) Foreign Application Priority Data
Mar. 17, 2006 (JP) 2006-074349

(51) Int. Cl. G03G 9/10

(52) U.S. Cl. 430/111.1; 430/111.41

(57) ABSTRACT

A carrier contained in a two component developer used for an image formation method of forming a color image by sequentially transferring multiple color toner images, wherein the carrier resistance R1 of a carrier in a developer, with which a toner image is transferred first, is adjusted to be less than the carrier resistances R2 to Rn (“n” represents a total color number of toners which form images, n≧2) of the carrier in two component developers for each color, which are transferred thereafter. The carrier resistances R1 to Rn of each carrier are adjusted as follows: R1<R2< . . . <Rn according to the order of toner images to be transferred.

Priority is claimed to Japanese Patent Application No. 2006-074349 filed on Mar. 17, 2006, the disclosure of which is incorporated by reference in its entirety.

### BACKGROUND OF THE INVENTION

1. Field of the Invention

The present invention relates to a carrier used for formation of full color images using an electrophotographic system, an image formation method, and an image forming apparatus such as copy machines, printers, facsimiles and a so-called multi-function peripherals which have functions of copy machine, printer and facsimile.

2. Description of Related Art

As an image forming apparatus, there has hitherto been studied a one drum color superimposing system wherein a plurality of color images are sequentially formed on a photoreceptor. The system enables a color image formation with less color shift by precisely superimposing a toner on a photoreceptor, and has drawn attention as a technology which copes with higher color image quality.

On the other hand, a tandem system has recently been drawing attention, wherein using plural photoreceptors corresponding to a toner color, a toner image of each color is formed by synchronizing with the feed of a transfer member so as to superimpose color on the transfer material. The system has such merits as providing a high quality image and excelling in high-speed performance.

In the tandem system, since a full color image is obtained by sequentially transferring monochromic toner images, followed by superimposition thereof, a toner image transferred at the first time passes through the following transfer process, and thus the toner is charge injected and there arise problems such as transfer defect in case of simultaneously transferring on a recording material such as paper. Also, in case of fixing thereof, excessive charge leads to problems such as static scattering and static offset.

In order to solve these problems, in Japanese Unexamined Patent Publication (Kokai) No. 2002-23459, a method for preventing reverse transfer of a toner, which comprises adjusting an amount of an external additive, Sn, contained in the toner in each toner supply means as follows: S1>S2>S3> . . . >Sn when Sn is defined as S1, S2, S3, S4, Sn in order from the upstream side. However, since a change of an amount of the external additive, particularly hydrophobic silica, exerts a large influence on fluidity of the toner, there arises such problems that it is required to vary conditions every color in the development process.

Thus, in the system wherein a toner image of each color is formed by synchronizing with the feed of a transfer material and multiple colors are superimposed on the transfer material, an image transferred at the upper stream side passes through plural transfer processes, thus causing reduced concentration by charge up, transfer defect such as transfer scattering, and furthermore, fixing defect such as static scattering and static offset.

### SUMMARY OF THE INVENTION

A main object of the present invention is to provide a carrier for color developer, which eliminates transfer and fixing defects in a system wherein a color image is formed by superimposing multiple color toner images on a transfer member through synchronizing with the feed of the transfer member.

The present inventors had intensively studied so as to solve the above problems and found a novel fact that, in the system wherein multiple color toner images are formed by synchronizing with the feed of the transfer member and a plurality of colors are superimposed on the transfer member, transfer and fixing defects can be prevented by adjusting the resistance of a carrier in a developer, with which a first toner image is transferred, to be less than those in developers for each color, which are transferred thereafter.

That is, the carrier of the present invention is contained in a two component developer used for an image formation method of forming a color image by sequentially transferring multiple color toner images, wherein the carrier resistance R1 of a carrier in a developer, with which a toner image is transferred first, is adjusted to be less than the carrier resistances R2 to Rn (“n” represents a total color number of toners which form images, n>2) of the carrier in two component developers for each color, which are transferred thereafter. The carrier resistances R1 to Rn of each carrier may be preferably adjusted as follows: R1<R2< . . . <Rn according to the order of toner images to be transferred.

The image formation method of the present invention is an image formation method for forming a color image by sequentially transferring multiple toner images, wherein the carrier resistance R1 of a carrier in a developer, with which a toner image is transferred first, is adjusted to be less than the carrier resistances R2 to Rn (n represents a total color number of toners which form images, n>2) of the carrier in two component developers for each color, which are transferred thereafter.

The image forming apparatus of the present invention is an image forming apparatus comprising a plurality of image supporting materials that are arranged along the moving direction of a transfer medium and sequentially transfer toner images on the transfer medium, and a plurality of developer supporting materials which supply a toner on these respective image supporting materials from two component developers to form toner images, wherein the carrier resistance of the carrier in a developer to be transferred first is less than that of carriers in developers for each color to be transferred thereafter.

According to the present invention, in an image formation method wherein multiple color toner images are formed by synchronizing with the conveyance of a transfer member and multiple color toner images are superimposed on the transfer member, charge up by repeated transfer can be suppressed by controlling the resistance of carriers in a plurality of two component developers. As a result, decrease in concentration, transfer defect such as transfer scattering, and furthermore, fixing defect such as static scattering or static offset can be prevented. Also, since an amount of an external additive added to a toner is not specifically limited, it becomes possible to set fluidity of the toner an state best suited for the system

### BRIEF DESCRIPTION OF THE DRAWINGS

FIG. 1 is a schematic view showing an image forming apparatus according to an embodiment of the present invention.

### DETAILED DESCRIPTION OF PREFERRED EMBODIMENTS

Hereinafter, an embodiment of the present invention will be described in detail. A carrier according to the present embodiment are used for a tandem type color image forming apparatus wherein a plurality of image supporting materials (hereinafter may also be referred to as a photoreceptor drum) are arranged on transcript such as an intermediate transfer belt, an intermediate transfer drum or a transfer conveyance belt. In that case, carrier resistance of a carrier in a developer to be transferred first is lower than that of carriers in developers for each color to be transferred thereafter.

In case of a system which comprises a plurality of image forming portions of forming a toner image on a photoreceptor drum using a development device and repeats the process of sequentially transferring onto an intermediate transfer body, like the tandem type image forming apparatus, a toner transferred at the upper stream side (the side where a toner image is transferred earlier) is charged in the following transfer process and, in the process of simultaneously transferring of a finally full-colored toner image on a recording material, the charge amount remarkably increases, resulting in transfer defect. In addition, excessive charge may cause easy occurrence of transfer scattering (toner scattering). In the fixing process, as a result of an influence of a high charge amount, there may arise problems such as static scattering due to a static repulsive force with a fixing roller, and static offset due to static adhesion.

Herein, it is a toner to be transferred at the uppermost stream, which exerts a largest influence on a charge up phenomenon. When the electric charge amount increases by a fist transfer, the charge is further accumulated by charging at the lower stream side and charge up is likely to occur at the lower stream side.

Generally, the charge level of a carrier is proportional to the carrier resistance of a carrier. When the carrier resistance of the carrier is high, the charge level increases. On the other hand, when the carrier resistance is low, the charge level decreases.

In the present invention, therefore, the carrier resistance of the carrier in a developer located on the uppermost stream side is adjusted to be less than that of carriers in developers located on the lower stream side, and thus the charge of the carrier at the upstream side decreases. Consequently, the charge amount to the toner at the upstream side can be suppressed, charge up on downstream side can be decreased, and the above problems in transfer and fixing processes can be eliminated.

Also, it is effective to decrease the carrier resistance of the carrier in a developer located at the uppermost stream side, but it is more preferable to gradually increase the carrier resistance of carriers in order from the upstream toward the downstream. As a matter of course, in the case where the carrier resistance of the carrier is lower than that of a carrier in a developer located at the uppermost stream, the carrier resistance of carriers at the lower stream can be configured in the same or different combination.

The carrier resistance of the carrier is preferably in the range from 1.0×10¹⁰ to 1.0×10¹⁶ Ω·cm, more preferably from 1.0×10¹¹ to 1.0×10¹⁵ Ω·cm, in terms of a volume resistivity value. In the case where the carrier resistance of the carrier is lower than the above range, fog and toner scattering tend to be caused by low electric charge. When the carrier resistance of the carrier is higher than the above range, the above-described transfer and fixing defects tend to increase.

The carrier resistance of the carrier can be adjusted by using a conductant agent. The conductant agent is used by adding to a resin for coating the surface of the carrier. Examples of the conductant agent includes carbon black such as carbon black or acetylene black, carbide such as SiC, magnetic powder such as magnetite, and SnO₂ and titanium black.

The particle size of the conductant agent is a particle size which enables uniform dispersion in a coating resin. Specifically, the particle size is preferably adjusted in a range from 0.01 to 2.0 μm, and more preferably from 0.01 to 1.0 μm. The amount to be added to a carrier core is commonly in a range from 0 to 40 parts by weight, preferably from 1 to 30 parts by weight, based on 100 parts by weight of a carrier coating resin.

The material for coating the carrier coat is coated on the carrier core in an amount in a range from 10 to 60 parts by weight, and preferably from 20 to 40 parts by weight, based on 1,000 parts by weight of the carrier core.

The coat material coated on the carrier is used for the purpose of improving the charge level. Examples of the resin for coating the surface of the carrier used in the present invention include polyolefin resins such as polyethylene, polypropylene, chlorinated polyethylene and chlorosulfonated polyethylene; polyvinyl and polyvinylidene resins such as 1S polystyrene, acrylic (for example, polymethyl methacrylate), polyacrylonitrile, polyvinyl acetate, polyvinyl alcohol, polyvinyl butylal, polyvinyl chloride, polyvinyl carbazole, polyvinyl ether and polyvinyl ketone; vinyl chloride-vinyl acetate copolymer; silicone resin comprising organosiloxane bonds, or the modified compounds (for example, modified with alkyd resin, polyester resin, epoxy resin or polyurethane resin); fluorinated resins such as polytetrafluoroethylene, polyvinyl fluoride, polyvinylidene fluoride and polychlorotrifluoroethylene; polyamide; polyester; polyurethane; polycarbonate; amino resins such as urea-formaldehyde resin; and epoxy resin.

The material of the carrier core used in the present invention is not particularly limited and known ones as an electrophotographic two component system carrier for electrophotography can be used. Examples thereof include ferrite, magnetite, metals such as iron, nickel and cobalt, alloys or mixtures of the prior metal or the like and a metal such as copper, zinc, antimony, aluminum, lead, tin, bismuth, beryllium, manganese, magnesium, selenium, tungsten, zirconium and vanadium, mixtures of the prior ferrite or the like and a metal oxide such as iron oxide, titanium oxide and magnesium oxide, nitride such as chromium nitride and vanadium nitride, or carbide such as silicone carbide and tungsten carbide, and ferromagnetic ferrite.

The particle size of the carrier is commonly in a range from 20 to 200 μm, preferably from 30 to 150 μm, in terms of an average particle size by electromicroscopy. The apparent density of the carrier is preferably in a range from 2.4 to 3.0 g/cm³, although it varies depending on the composition or surface structure of the magnetic material when the magnetic material is used the major constituent.

### (Toner)

The toner used for in present invention can be obtained by adding a predetermined amount of a colorant and optionally adding additives such as a wax and a charge control agent to a predetermined amount of a binder resin, followed by mixing with stirring using a mixer such as Henschell mixer. The mixture obtained by mixing with stirring is melt kneaded using a biaxial extruder, cooled and ground using a grinder such as a hammer mill or a jet mill. Then, the ground mixture is classified using a classifier such as a wind power classifier to obtain toner particles having a predetermined particle size.

Then, a predetermined amount of an inorganic oxide and, if necessary, a surface treatment agent such as silica are externally added to the resulting toner, followed by mixing with stirring in a mixer such as a Henschell mixer to obtain a toner.

The toner according to the present invention is used after the resulting toner is mixed with the coating treated carrier to obtain a two component system full color developer.

The toner concentration of a two component system developer is in a range from 1 to 20% by weight, and preferably from 3 to 15% by weight. In the case where the toner concentration is less than 1% by weight, image density may be too low. While in the case where the toner concentration exceeds 20% by weight, toner scattering may occur in a development device, which may cause stain in the apparatus or a problem such as deposition of the toner on the background of a transfer paper.

### (Binder Resin)

The binder resin is not specifically limited and it is preferable to use thermoplastic resins such as polystyrene-based resin, acrylic resin, styrene-acrylic copolymer, polyethylene-based resin, polypropylene-based resin, polyvinyl chloride-based resin, polyester-based resin, polyamide-based resin, polyurethane-based resin, polyvinyl alcohol-based resin, vinyl ether-based resin, N-vinyl-based resin and styrene-butadiene resin.

Specifically, the polystyrene-based resin may be a styrene homopolymer or copolymer with a copolymerization monomer which can be copolymerizable with styrene. Specifically, a polystyrene-based resin. Examples of the copolymerization monomer include p-chlorostyrene; vinylnaphthalene; ethylene unsaturated monoorefins such as ethylene, propylene, butylene and isobutylene; vinyl halides such as vinyl chloride, vinyl bromide and vinyl fluoride; vinyl esters such as vinyl acetate, vinyl propionate, vinyl benzoate and vinyl butylate; (meth)acrylic acid ester such as methyl acrylate, ethyl acrylate, n-butyl acrylate, isobutyl acrylate, dodecyl acrylate, n-octyl acrylate, 2-chloroethyl acrylate, phenyl acrylate, methyl α-chloroacrylate, methyl methacrylate, ethyl methacrylate and butyl methacrylate; other acrylic acid derivatives such as acrylonitrile, methacrylonitrile and acrylic amide; vinyl ethers such as vinyl methyl ether and vinyl isobutyl ether; vinyl ketones such as vinyl methyl ketone, vinyl ethyl ketone and methyl isopropenyl ketone; and N-vinyl compounds such as N-vinyl pyrrole, N-vinyl carbazole, N-vinyl indole and N-vinyl pyrollidene. These monomers can be used alone, or two or more kinds can be combined and copolymerized with a styrene monomer.

A polystyrene-based resin preferably has two peaks of weight average molecular weight (a low molecular weight peak and a high molecular weight peak). Specifically, the low molecular weight peak falls within a range from 3,000 to 20,000, while the high molecular weight peak falls within a range from 300,000 to 1,500,000, and the ratio of weight average molecular weight (Mw) to number average molecular weight (Mn), (Mw/Mn), is preferably 10 or more. In the case where the weight average molecular weight falls within the range, a toner can be easily fixed and offset resistance can be improved. Incidentally, the weight average molecular weight and the number average molecular weight of a binder resin are found by measuring the elusion time from a column by using a molecular weight analyzer (GPC), and comparing the time with that on a calibration curve prepared in advance using a standard polystyrene.

As a polyester-based resin, those obtained by polycondensation or copolycondensation of an alcohol component and a carboxylic acid component can be used. As a component used for synthesis of a polyester-based resin is exemplified as follows.

Examples of the dihydric, trihydric or polyhydric alcohol component include diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexane dimethanol, dipropylene glycol, polyethylene glycol, polypropylene glycol and polytetramethylene glycol; bisphenols such as bisphenol A, hydrogenated bisphenol A, polyoxyethylenated bisphenol A and polyoxypropylenated bisphenol A; and trihydric or polyhydric alcohols such as sorbitol, 1,2,3,6-hexane tetrol, 1,4-sorbitan, pentaerythritol, dipentaerythritol, tripentaerythritol, 1,2,4-butanetriol, 1,2,5-pentatriol, glycelol, diglycelol, 2-methylpropanetriol, 2-methyl-1,2,4-butanetriol, trimethylol ethane, trimethylol propane and 1,3,5-trihydroxymethylbenzene.

As the dihydric, trihydric or polyhydric carboxylic acid component, a dihydric or trihydric carboxylic acid, acid anhyrides thereof, or lower alkyl ester thereof are used, and examples thereof include maleic acid, fumaric acid, citraconic acid, itaconic acid, glutaconic acid, phthalic acid, isophthalic acid, terephthalic acid, cyclohexanedicarboxylic acid, succinic acid, adipinic acid, sebacic acid, azelaic acid, malonic acid, or dihydric alkyl or alkenylsuccinic acids such as n-butylsuccinic acid, n-butenylsuccinic acid, isobutylsuccinic acid, isobutenylsuccinic acid, n-octylsuccinic acid, n-octenylsuccinic acid, n-dodecylsuccinic acid, n-dodecenylsuccinic acid, indodecylsuccinic acid and indodecenylsuccinic acid; and trihydric or polyhydric carboxylic acids such as 1,2,4-benzenetricarboxylic acid (trimellitic acid), 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxylicl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid and enpole trimer acid.

The softening point of the polyester-based resin is preferably from 110 to 150° C., and more preferably from 120 to 140° C., when measured by a Koka flow tester.

The binder resin is preferably a thermoplastic resin in view of good fixing properties, however, a thermosetting resin may also be used as long as the amount of the crosslinked moiety (gel volume) is 10% by weight or less, preferably in the range from 0.1 to 10% by weight, when measured by a Soxhlet extractor. Thus, by partly introducing a crosslinking structure, storage stability, form retention or durability of a developer can be improved without deteriorating fixing properties. Accordingly, it is not necessary to use a thermoplastic resin of 100% by weight as a binder resin for a toner body, and a crosslinking agent can be added, or a thermosetting resin can partly be used.

As a thermosetting resin, epoxy-based resin and cyanate-based resin can be used. Specific examples thereof include bisphenol A type epoxy resin, hydrogenated bisphenol A type epoxy resin, novolak type epoxy resin, polyalkylene ether type epoxy resin, alicyclic epoxy resin, cyanate resin, and mixtures thereof.

With regard to a binder resin, it is preferable to use a resin having at least one functional group in the molecule, which is selected from hydroxyl, carboxyl, amino and glycidoxy groups so as to improve dispersibility of a magnetic powder. Whether or not the resin has these functional groups can be confirmed by using Fourier-transform infrared spectroscopy (FT-IR instrument), and furthermore it is possible to determine using a titration method.

The glass transition point (Tg) of the binder resin is preferably within a range from 55 to 70° C. In the case where the glass transition point of the binder resin becomes 55° C. or less, the resulting toners could be fused with each other and thus storage stability may deteriorate. On the other hand, in the case where the glass transition point of a binder resin exceeds 70° C., fixing properties of a toner may deteriorate. Incidentally, the glass transition point of the binder resin can be determined from a variation point of specific heat using a differential scanning calorimeter (DSC).

### (Colorant)

Examples of the colorants include carbon black such as acetylene black, lamp black and aniline black as a black pigment; chrome yellow, zinc yellow, cadmium yellow, yellow iron oxide, mineral fast yellow, nickel titanium yellow, naples yellow, naphthol yellow S, hansa yellow G, hansa yellow 10G, benzidine yellow G, benzidine yellow GR, quinoline yellow lake, permanent yellow NCG and tartrazine yellow lake as a yellow pigment; orange chrome, molybdenum orange, permanent orange GTR, benzidine orange G and indusrene brilliant orange GK as a orange pigment; colcothar, cadmium red, minium, mercury sulfide cadmium, permanent red 4R, lithol red, pyrazolone red, watching red calcium salt, lake red D, brilliant carmine 6B, eosin lake, rodamine lake, arizaline lake and brilliant carmine 3B as a red pigment; manganese purple, fast violet B and methyl violet lake as a violet pigment; iron blue, cobalt blue, alkali blue lake, victoria blue lake, phthalocyanine blue, metal free phthalocyanine blue, partially chlorinated phthalocyanine blue, fast sky blue and indusrene blue BC as a blue pigment; chrome green, chrome oxide, pigment green B, marakite green lake and fanal yellow green G as a green pigment; Chinese white, titanium oxide, antimony white and zinc sulfide as a white pigment; and barytes, barium carbonate, clay, silica, white carbon, talc and alumina white as a white pigment. These colorants are preferably used in an amount in a range from 2 to 20 parts by weight, and more preferably from 5 to 15 parts by weight, based on 100 parts by weight of a binder resin.

To the developer of the present invention, other additives can be added as long as an adverse effect is not exerted on the present invention. Examples of these additives include waxes and charge control agents.

### (Wax)

The wax is not specifically limited and examples thereof include vegetable waxes such as carnauba wax, sugar wax and tree wax; animal waxes such as insect wax, whale wax and wool wax; and synthetic hydrocarbon-based waxes such as Fisher-Tropsch wax (FT wax) having ester on the side chain, polyethylene wax and polypropylene. Among these waxes, carnauba wax, Fisher-Tropsch wax having ester on the side chain and polyethylene wax are preferably used in view of dispersibility.

A preferable wax also has an endothermic main peak between 70 and 100° C. in an endothermic curve by a differential scanning calorimeter. In the case where the endothermic main peak is lower than 70° C., toner blocking and hot offset could occur, while in the case where it exceeds 100° C., low fixing properties could not be obtained.

Furthermore, the amount of wax to be added is preferably in a range from 0.1 to 20 parts by weight based on 100 parts by weight the binder resin. In the case where the amount of wax is less than 0.1 parts by weight, the effect of a wax could not be sufficiently obtained, while in the case where it exceeds 20 parts by weight, blocking resistance decreases and desorption from a toner body could occur.

### (Charge Control Agent)

As the charge control agent, known charge control agents can be used. Examples of a positive charging charge control agent includes nigrosine dyes, nigrosine modified fatty acid, carboxyl group-containing nigrosine dyes modified with fatty acid, quaternary ammonium salts, amine-based compounds and organic metal compounds. Examples of the negative charging charge control agent include metal complexes of oxycarboxylic acid, metal complexes of azo compounds, metal complex dyes and salicylic acid derivatives.

### (External Additive)

To adjust charge control properties and fluidity of the toner, one or more external additives can be added. Examples of the external additive include inorganic fine powders such as powders of silica, titanium oxide, alumina, zinc oxide, magnesium oxide and calcium carbonate; organic fine powders such as powders of polymethylmethacrylate; and metal salts of fatty acid such as zinc stearate. The amount of the external additive to be added is preferably in a range from 0.1 to 5.0% by weight based on toner particles. The mixture of the external additive and toner particles can be conducted by using, for example, a Henschell mixer, a V-type mixer, a Tarbra mixer or a hybridizer.

The surface of the inorganic fine powder may be untreated, or optionally treated with a silane coupling agent, aminosilane, silicone oil or a titanate coupling agent so as to hydrophobize the powder or control charge characteristics.

The amount of these surface treatment agents to be used is preferably in a range from 0.05 to 20 parts by weight based on 100 parts by weight of the external additive.

Examples of the silane coupling agent include organoalkoxysilane (for example, methoxytrimethylsilane, dimethoxydimethylsilane, trimethoxymethylsilane and ethoxytrimethylsilane); organochlorosilane (for example, trichloromethylsilane, dichlorodimethylsilane, chlorotrimethylsilane, trichloroethylsilane, dichlorodiethylsilane, chlorotriethylsilane and trichlorophenylsilane); organosilazane (for example, triethylsilazane, tripropylsilazane and triphenylsilazane); organodisilazane (for example, hexamethyldisilazane, hexaethyldisilazane and hexaphenyldisilazane); and other organosilazane. These silane coupling agents can be used alone or in combination. Among these silane coupling agents, organochlorosilane, organosilazane and organodisilazane are preferably used.

Examples of preferable aminosilane include N-2(aminoethyl)3-aminopropylmethyldimethoxysilane, N-2(aminoethyl)3-aminopropyltrimethoxysilane, N-2(aminoethyl)3-aminopropyltriethoxysilane 3-aminopropyltrimethoxysilane, 3-aminopropyltriethoxysilane, and N-phenyl-3-aminopropyltrimethoxysilane. Among these aminosilanes, 3-aminopropyltrimethoxysilane is preferably used.

Examples of the silicone oil include dimethyl silicone oil, methylphenyl silicone oil, methylhydrogen silicone oil, fluorosilicone oil and modified silicone oil. These oils can be used alone or in combination. If necessary, the silicone oil could be hardened by a crosslinking agent or a heat treatment. Among these silicone oils, dimethyl silicone oil is preferably used.

Examples of the titanate coupling agent include isopropyltriisostearoyl titanate, isopropyltrichromylphenyl titanate and tetraisopropylbis(dioctylphosphite)titanate. These titanate coupling agents could be used alone or in combination. Among these titanate coupling agents, isopropyltriisostearoyl titanate is preferably used.

### (Image Forming Apparatus)

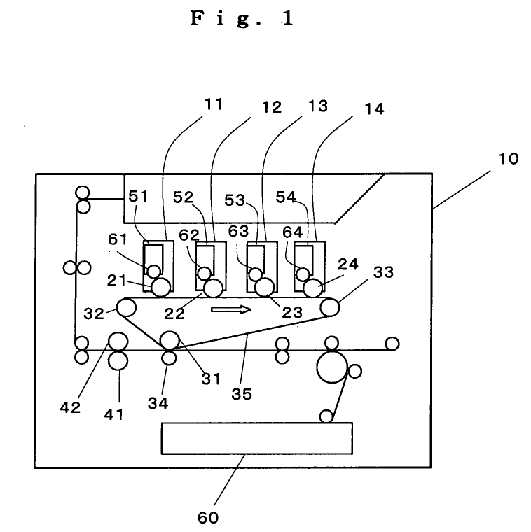

Hereinafter, a color image forming apparatus capable of preferably using a full color developer of the present invention will be described. FIG. 1 is a schematic cross section showing an example of a tandem type color image forming apparatus (indirect transfer tandem system) wherein four photoreceptor drums (image supporting materials) are arranged on an intermediate transfer belt (transfer material) 35.

As shown in FIG. 1, in a housing 10 of the image forming apparatus, an intermediate transfer belt 35, which runs with being hung on rollers 31, 32 and 33, is disposed. On the intermediate transfer belt 35, four image forming devices 11, 12, 13 and 14 are disposed in the order of transfer of a toner image (in order from the upstream side).

Image forming devices 11, 12, 13 and 14 have such a structure that a charging device (not shown), an exposure device (not shown), development devices 51, 52, 53 and 54, and a cleaning device (not shown) are disposed around photoreceptor drums (image supporting materials) 21, 22, 23 and 24, respectively. These photoreceptor drums 21, 22, 23 and 24 are arranged along the moving direction of the intermediate transfer belt 35.

A development device 51 in the image forming device 11 is equipped with a development sleeve 61 and a stirring member (not shown) and, on the upper portion of the development sleeve 61, a blade (not shown) is disposed at a predetermined distance from the development sleeve 61 so as to control the amount of a developer conveyed to the development portion and to provide frictional electrification. A toner hopper (not shown) is disposed above the stirring member. The toner hopper contains a toner (magenta toner) therein. Other image forming devices 12, 13 and 14 have the same configuration as in the image forming device 11. The toner hoppers of these image forming devices 12, 13 and 14 contain a cyan toner, a yellow toner and a black toner. The toners are used as developers after mixing with a carrier having the adjusted resistance.

Next, an image forming process of the image forming devices will be described. With reference to the image forming device 11 as an example, the surface of the photoreceptor drum 21 is positively charged, uniformly, using a charging device. Then, a static latent image is formed on the surface of the photoreceptor drum 21 by an exposure device.

In the development device 51 located at the image forming portion 51, a toner is mixed with a carrier using the stirring member and then sequentially fed to the development sleeve 61. The toner and the carrier fed form a layer of a developer on the development sleeve 61. The developer on the development sleeve 61 is fed to the opposite side of the photoreceptor drum 21 (development portion) by an anticlockwise rotation of the development sleeve 61. At that time, the amount of the developer fed to the development portion is controlled by a blade and frictional electrification is provided to the toner. The charged toner is adhered on the static latent image formed on the photoreceptor drum 21 and thus the static latent image is visualized (developed) to form a toner image. In other image forming devices 12, 13 and 14, the static latent images are visualized on the photoreceptor drums 22, 23 and 24 in the same manner to form images, respectively.

In this image forming device, visualized toner images on the photoreceptor drums 21, 22, 23 and 24 are sequentially transferred onto the surface of the intermediate transfer belt 35 from the photoreceptor drum 21 located at the upper stream side. Then, a full color image transferred on the intermediate transfer belt 35 is transferred onto a transfer paper (not shown), which is conveyed from a paper feeding cassette 60 between a roller 34 and a transfer roller 35. A toner which was not transferred onto the intermediate transfer belt 35 is removed by a cleaning device. After applying heat and pressure in a fixing device equipped with fixing rollers 41 and 42, the full color image fixed on the transfer paper is fused and fixed on the transfer paper and then the transfer paper is discharged over the housing 10.

The full color developer of the present invention can be used preferably for a tandem type color image forming apparatus (direct transfer tandem system) wherein the above four photoreceptor drums (image supporting materials) are arranged on a transfer conveyance belt (transfer body), a bias charge with reverse polarity to the charge polarity of a toner is applied to a transfer roller (not shown) provided under the intermediate transfer belt, and toner images of each color formed on plural photoreceptor drums are sequentially transferred onto the transfer paper conveyed on the transfer conveyance belt from the photoreceptor drum at the upstream side.

A method for developing a static latent image on each photoreceptor drum may be a positive development method or a reverse development, and a development method may be a contact development system wherein a developer layer and a photoreceptor drum are contacted, or a jumping development system wherein the both are not contacted. In view of obtaining a high quality image, reverse development is preferable. In this case, a photoreceptor drum is charged to the same polarity as that of a toner, and charge accumulated in a latent image region is removed by exposure. By applying an alternate voltage, which is prepared by superimposition of a direct current and an alternate current, as a development, bias between a development sleeve and a photoreceptor drum in a development portion, a toner in a developer is moved to a static latent image having no charge on a photoreceptor drum and adhered, thereby visualizing a toner image.

The material of the photoreceptor drum used in the present invention is not specifically limited and a conventionally known material can be used. Examples of the photoreceptor include amorphous silicone-based photoreceptor, organic photoreceptor, Se-based photoreceptor, ZnO photoreceptor and CdS-based photoreceptor. Among these photoreceptors, an amorphous silicone photoreceptor is preferable in view of durability.

The present invention will now be described in detail by way of Examples and Comparative Examples, but the present invention is not limited to the following Examples.

### EXAMPLES

In order to prepare a developer of the present invention, first, a mixture with the composition shown in Table 1 was mixed using a Henschell mixer, melt kneaded using a roll mill, cooled and then ground using a jet mill. The resulting ground powder was classified to give toner particles having a volume average particle size of 9 to 10 μm.

Then, 1.0 parts by weight of hydrophobic silica fine particles of and 0.5 parts by weight of titanium oxide fine particles are added to 100 parts by weight of the resulting toner particles, followed by mixing using a Henschell mixer for 4 minutes to give a toner of the present invention.

TABLE 1

| | 1st Transferring | 2nd Transferring | 3rd Transferring | 4th Transferring |
|---|---|---|---|---|
| | Toner (Magenta) | Toner (Cyan) | Toner (Yellow) | Toner (Black) |
| Binder | Polyester Resin | Polyester Resin | Polyester Resin | Polyester Resin |
| Resin | | | | |
| pbw | 100 | 100 | 100 | 100 |
| Wax | Carnauba Wax | Carnauba Wax | Carnauba Wax | Carnauba Wax |
| pbw | 10 | 10 | 10 | 10 |
| Colorant | Quinacridone | Phtalocyanine | Azo Pigment | Carbon Black |
| | Pigment | Pigment | | |
| pbw | 4 | 3 | 4 | 4 |
| Charge | Quaternary | Quaternary | Quaternary | Quaternary |
| Control Agent | Ammonium Salt | Ammonium Salt | Ammonium Salt | Ammonium Salt |
| pbw | 3 | 3 | 3 | 3 |

pbw: parts by weight

The hydrophobic silica fine particles were prepared by the following method. First, the silica CA-200H manufactured by JAPAN AEROSIL CO. was ground and adjusted using a jet mill, IDS-2 type manufactured by NIPPON PNEUMATIC MFG. CO., LTD. so as to obtain a silica having a predetermined specific surface area. 100 parts by weight of the resulting silica fine particles were charged in an airtight Henschell and 20 parts by weight of a hydrophobized agent prepared by mixing 3-aminopropyltriethoxysilane and dimethylsilicone oil in an equivalent amount by part was uniformly sprayed over the silica fine particles, and then the silica fine particles were subjected to a hydrophobization treatment by reacting at 100° C. for 2 hours with mixing. Then, by-products were removed under reduced pressure, followed by heating at 200° C. for one hour to obtain desired silica fine particles.

Cu-Zn ferrite core having an average particle size of 50 μm was used as a carrier and a silicone resin was used as the coating resin. 100 parts by weight of the silicone resin and a conductant agent shown in Table 2 were dissolved in 200 parts by weight of toluene to prepare a coating solution. Then, the resulting coating solution was sprayed over the carrier core using a fluidized bed coating equipment, followed by a heat treatment at 200° C. for 60 minutes to obtain a carrier of the present invention. The amount of the coating resin was 30 parts by weight based on 1,000 parts by weight of the carrier core.

Then, 8% of the toner prepared above was blended with the carrier prepared above, followed by mixed for 30 minutes using a ball mill to prepare developers of samples Nos. 1 to 9.

The volume resistivity value of the resulting carrier was measured by exposing the sample to the atmosphere at a temperature of 25° C. and a humidity of 60% and filled in an insulated cylindrical container equipped with an electrode measuring 5.0 cm² in section area and 0.5 cm in height, and then a load of 1 kg and a voltage of 500 V were applied, using ULTRA HIGH RESISTANCE METER (manufactured by ADVANTES CO., LTD.), wherein the carrier resistance of a carrier in the first transfer is R1, that in the second transfer is R2, that in the third transfer is R3, and that in the fourth transfer is R4. These results are shown in Table 2.

TABLE 2

| | | | Amount of Conductant Agent¹⁾ | | | | | | | |
|---|---|---|---|---|---|---|---|---|---|---|
| | | | (parts by weight) | | | | | | | |
| | | | Carrier of | Carrier of | Carrier of | Carrier of | | | | |
| | Sample | Conductant | 1st | 2nd | 3rd | 4th | Volume Resistivity (Ω · cm)²⁾ | | | |
| | No. | Agent | Transfer | Transfer | Transfer | Transfer | R1 | R2 | R3 | R4 |
| | 1 | Carbon | 7 | 5 | 3 | 1 | 1.67 × 10¹⁰ | 2.13 × 10¹² | 5.98 × 10¹³ | 3.04 × 10¹⁶ |
| | | Black | | | | | | | | |
| | 2 | Carbon | 7 | 1 | 1 | 1 | 1.67 × 10¹⁰ | 3.04 × 10¹⁶ | 3.04 × 10¹⁶ | 3.04 × 10¹⁴ |
| | | Black | | | | | | | | |
| | 3 | Magnetite | 30 | 25 | 20 | 15 | 9.03 × 10¹² | 5.04 × 10¹³ | 9.87 × 10¹³ | 6.04 × 10¹⁴ |
| | 4 | Magnetite | 30 | 15 | 15 | 15 | 9.30 × 10¹² | 6.04 × 10¹⁴ | 6.04 × 10¹⁴ | 6.04 × 10¹⁴ |
| | 5 | Carbon | 7 | — | — | 3 | 1.67 × 10¹⁰ | 9.30 × 10¹² | 5.04 × 10¹³ | 5.98 × 10¹³ |
| | | Black | | | | | | | | |
| | | Magnetite | — | 30 | 25 | — | | | | |
| * | 6 | Carbon | 1 | 1 | 1 | 1 | 3.04 × 10¹⁶ | 3.04 × 10¹⁶ | 3.04 × 10¹⁶ | 3.04 × 10¹⁶ |
| | | Black | | | | | | | | |
| * | 7 | Carbon | 1 | 3 | 3 | 3 | 3.04 × 10¹⁶ | 5.98 × 10¹³ | 5.98 × 10¹³ | 5.98 × 10¹³ |
| | | Black | | | | | | | | |
| * | 8 | Magnetite | 15 | 20 | 25 | 30 | 6.04 × 10¹⁴ | 9.87 × 10¹³ | 5.04 × 10¹³ | 9.30 × 10¹² |
| * | 9 | Carbon | — | 1 | 3 | — | 6.04 × 10¹⁴ | 3.04 × 10¹⁶ | 5.98 × 10¹³ | 5.04 × 10¹³ |
| | | Black | | | | | | | | |
| | | Magnetite | 15 | — | — | 25 | | | | |

Sample numbers marked with * are not within the scope of the present invention.
¹⁾Value to 100 parts by weight of silicone resin.
²⁾Volume resistivity value of carrier.

### (Evaluation Test and Evaluation Method)

Any one of developers of samples Nos. 1 to 9 obtained above is was mounted in a printer (FS-C5016N) manufactured by KYOCERA MITA CORP. and printing evaluation was performed. As a print pattern, samples containing a 100% of a solid portion, a 50% of a halftone portion and a letter portion were used, and a concentration defect, transfer (toner) scattering and static offset were studied. These results are shown in Table 3.

The images on the solid portions were such that the toner images of each color from the 1^{st} to the 4^{th} did not overlap with each other, so as that a toner charge just after the first transfer on the intermediate transfer belt (transfer voltage of 1.2 kV) and a toner charge just after the second transfer on paper (transfer voltage of 2.0 kV) can be measured.

### (Measurement of Charge Amount)

With regard to toner images formed on the photoreceptor drums 21 to 24, from the development sleeves 61 to 64, a charge amount of the toner on the intermediate transfer belt 35 just after the first transfer thereon and a charge amount of the toner on paper just after the second transfer from the intermediate transfer belt 35 to paper were measured by the following method.

Each solid image on the intermediate transfer belt was uniformly sucked for 15 minutes by using a sucking charge measuring equipment (Q/Mmeter210HS) manufactured by TREK INC. to measure a thin layer of a toner on the intermediate transfer belt just after the first transfer, with particularly paying attention to not sucking an extra toner from the periphery of a nozzle of the charge measuring equipment. That is, since the toner on the periphery, particularly that on a surface of the thin layer, is highly charged, the influence needs to be removed. Therefore, such methods as cutting out a necessary toner layer with a rubber blade or using a rectangular dividing jig which fits for the sleeve are employed in an effort of not sucking an extra toner from wider area than the diameter of the nozzle.

A toner charge just after the second transfer was measured in the same manner as in the first transfer, that is, measured directly using the charge measuring equipment by uniformly sucking the toner on the solid image on paper for 15 minutes. The results are shown in Table 3.

The evaluation method and the evaluation criteria are as follows.

### (1) Image Density

100 sheets of paper were continuously printed, and uniformity at the 100% solid portion and 50% halftone portion were mainly evaluated. The evaluation criteria are as follow: the case with uniformity in concentration was rated as “o” (good), while the case with lack of uniformity in concentration was rated as “x” (poor).

### (2) Toner Scattering

100 sheets of paper were continuously printed, and toner scattering at the letter part was visually observed, mainly. The evaluation criteria are as follows: the case without toner scattering was rated as “o” (good), the case with a little toner scattering was rated as “Δ” (slightly poor) and the case with remarkable toner scattering was rated as “x” (poor).

### (3) Static Offset

100 sheets of paper were continuously printed, and whether offset occurred at the 100% solid portion in a cycle of a fixing roller was observed by visual. The evaluation criteria are as follows: the case without static offset was rated as “o” (good), the case with a little static offset was rated as “Δ” (slightly poor) and the case with remarkable static offset was rated as “x” (poor)

TABLE 3

| | | Toner Charge | | | | | | | | | | |
|---|---|---|---|---|---|---|---|---|---|---|---|---|
| | | Just After | | | | Toner Charge Just | | | | | | |
| | Sample | 1st Transfer (μC/g) | | | | After 2nd Transfer (μC/g) | | | | Image | Toner | Static |
| | No. | 1st | 2nd | 3rd | 4th | 1st | 2nd | 3rd | 4th | Density | Scattering | Offset |
| | 1 | 10 | 14 | 16 | 20 | 30 | 29 | 26 | 25 | ◯ | ◯ | ◯ |
| | 2 | 10 | 20 | 20 | 20 | 30 | 31 | 28 | 25 | ◯ | ◯ | ◯ |
| | 3 | 14 | 16 | 16 | 18 | 35 | 32 | 27 | 24 | ◯ | ◯ | ◯ |
| | 4 | 14 | 18 | 18 | 18 | 35 | 29 | 27 | 24 | ◯ | ◯ | ◯ |
| | 5 | 10 | 14 | 16 | 16 | 30 | 29 | 26 | 25 | ◯ | ◯ | ◯ |
| * | 6 | 20 | 20 | 20 | 20 | 38 | 31 | 28 | 25 | X | Δ | X |
| * | 7 | 20 | 16 | 16 | 16 | 38 | 27 | 26 | 25 | X | ◯ | Δ |
| * | 8 | 18 | 16 | 16 | 14 | 36 | 30 | 28 | 24 | X | ◯ | Δ |
| * | 9 | 20 | 18 | 16 | 16 | 36 | 31 | 26 | 24 | X | ◯ | Δ |

Sample numbers marked with * are not within the scope of the present invention.

As shown in Table 3, the samples Nos. 6 to 9 outside the scope of the present invention had carrier resistance in the first place of transfer that was the same as, or less than that on the lower stream side thereof, with the result that particularly the toner located first was, after the first transfer, affected by multiple transfer voltage on the lower stream and the toner charge increased as compared to that on the lower stream side just after the second transfer, which resulted in occurrence of charge up. Thus, a transfer defect occurred, resulting in a decrease in image density and occurrence of static offset. In addition, in the sample No. 6, toner scattering was observed.

On the other hand, any of the samples Nos. 1 to 5 within the scope of the present invention had good image density, and no occurrence of toner scattering and static offset was confirmed.

What is claimed is:

1. A carrier contained in a two component developer used for an image formation method of forming a color image by sequentially transferring multiple color toner images, wherein the carrier resistance R1 of a carrier in a developer, with which a toner image is transferred first, is adjusted to be less than the carrier resistances R2 to Rn (“n” represents a total color number of toners which form images, n>2) of the carrier in two component developers for each color, which are transferred thereafter.

2. The carrier according to claim 1, wherein the carrier resistances R2 to Rn of the carrier may be the same or different from each another.

3. The carrier according to claim 1, wherein the carrier resistances R1 to Rn of each carrier are adjusted as follows: R1<R2< . . . <Rn according to the order of toner images to be transferred.

4. The carrier according to claim 1, wherein the carrier resistance R1 to Rn of each carrier has a volume resistivity value selected from a range of 1.0×10¹⁰ to 1.0×10¹⁶ Ω·cm.

5. The carrier according to claim 1, wherein each carrier having the carrier resistance of R1 to Rn contains the same or different conductant agent in a surface coating layer thereof.

6. The carrier according to claim 5, wherein the carrier resistances of R1 to Rn in each carrier is adjusted by the amount of the conductant agent contained in the surface coating layer of each carrier.

7. A two component developer used for an image formation method of forming a color image by sequentially transferring multiple color toner images, and comprising a carrier and a toner, wherein the carrier resistance R1 of a carrier in a developer, with which a toner image is transferred first, is adjusted to be less than the carrier resistances R2 to Rn (“n” represents a total color number of toners which form images, n>2) of the carrier in two component developers for each color, which are transferred thereafter.

8. The developer according to claim 7, wherein the toner concentration is 1 to 20% by weight in the developer.

9. An image formation method for forming a color image by sequentially transferring multiple toner images, wherein the carrier resistance R1 of a carrier in a developer, with which a toner image is transferred first, is adjusted to be less than the carrier resistances R2 to Rn (“n” represents a total color number of toners which form images, n>2) of the carrier in two component developers for each color, which are transferred thereafter.

10. The image formation method according to claim 9, wherein the carrier resistance of the carriers, R2 to Rn, could be the same or different.

11. The image formation method according to claim 9, wherein the carrier resistances R1 to Rn of each carrier are adjusted as follows: R1<R2< . . . <Rn according to the order of toner images to be transferred.

12. The image formation method according to claim 9, wherein the carrier resistance R1 to Rn of each carrier has a volume resistivity value selected from a range of 1.0×10¹⁰ to 1.0 ×10¹⁶ Ω·cm.

13. The image formation method according to claim 9, wherein the two component developer comprises a toner and a carrier, and the toner concentration in the two component developer is from 1 to 20% by weight.

14. An image forming apparatus comprising a plurality of image supporting materials that are arranged along the moving direction of a transfer medium and sequentially transfer toner images on the transfer medium, and a plurality of developer supporting materials which supply a toner on these respective image supporting materials from two component developers to form toner images, wherein the carrier resistance of the carrier in a developer to be transferred first is less than that of carriers in developers for each color to be transferred thereafter.
